(19) United States
(12) Patent Application Publication
(10) Pub. No.: US 2016/0191269 A1
(43) Pub. Date: Jun. 30, 2016

(54) IMMERSIVE COMPANION DEVICE RESPONSIVE TO BEING ASSOCIATED WITH A DEFINED SITUATION AND METHODS RELATING TO SAME

(71) Applicant: DADT Holdings, LLC, Westlake Village, CA (US)

(72) Inventors: Amir Niruyi, Westlake Village, CA (US); Derek Bacon, Westlake Village, CA (US)

(21) Appl. No.: 14/985,247

(22) Filed: Dec. 30, 2015

Related U.S. Application Data
(60) Provisional application No. 62/098,965, filed on Dec. 31, 2014.

(51) Int. Cl. H04L 12/28

(52) U.S. Cl. CPC H04L 12/2829; H04L 12/2807; H04L 12/282

(57) ABSTRACT

A system and method for immersive companion device responsive to being associated with a defined situation is disclosed. The system has at least one embedded computer system. The embedded computer system further contains a unique identifier, a communication interface and a set of active instructions. The system also has at least one input interface device configured to communicate with the embedded computer system to determine proximity to a defined situation and to enable additional features to be performed by the embedded computer system when associated with the defined situation.

### CROSS-REFERENCE TO RELATED APPLICATIONS

The present application claims the benefit of U.S. Provisional Application Ser. No. 62/098,965, filed on Dec. 31, 2014, the specification of which is herein incorporated by reference for completeness of disclosure.

### BACKGROUND OF THE INVENTION

1. Field of the Invention

Embodiments of the invention described herein pertain to the field of electronic immersive companion devices. More particularly, but not by way of limitation, one or more embodiments of the invention are directed to immersive companion devices responsive to being associated with a defined situation and methods relating to same.

2. Description of the Related Art

Current companion devices typically have pre-determined or pre-set actions. In some companion devices, these actions are activated by pressing a button or buttons. In some other companion devices, these actions may be triggered when the companion device senses a sound such as clapping. Current companion devices are passive, not dynamically reprogrammable, based on stimulus or defined situation.

### BRIEF SUMMARY OF THE INVENTION

One or more embodiments of the invention enable a system and method for immersive companion devices responsive to being associated with a defined situation. The immersive companion device may have an embedded computer system with at least one unique identifier. The immersive companion device may have a communication component to connect to the external world, e.g. Wi-Fi radio, Cellular radio, etc. The immersive companion device when associated with a defined situation may enable a set of active instructions. Enabling the active instructions results in an end effect in the companion device or by an external device, e.g. producing an audio output. Enabling active instructions, may enable additional features on the companion device.

The defined situation may be external environmental variables, e.g., proximity to a particular location, change in temperature, pressure, etc.; physiological characteristics of the owner of the companion device, e.g., facial characteristics, brainwave data, body temperature, changes in characteristics of blood, change in heart rhythm, etc.; or combinations thereof. The immersive companion device may determine its proximity to a defined situation by using a communication network and/or sensors. The immersive companion device may connect through a communication component to an external network.

The immersive companion device may receive updates to add, remove or update the active instructions. The updates may occur while connected to an external communication network. In one or more embodiments, changing a removable memory device in an embedded computer system may be all that is required to update the active instructions in the embedded computer system board or add additional memory.

The companion device may have a unique identifier, e.g., an email address, a serial number, or a social media profile. In one or more embodiments, the companion device may have a user profile, which in turn contains an email address or an online social network profile. In one or more embodiments, the unique identifier may be a near field identification chip.

The companion device may have active instructions, which are updateable, permanent or a mixture of both. The companion device may have active instructions, which are disabled or inactive. The active instructions may be dynamically reprogrammable. The active instructions of the companion device may adapt or evolve in response to stimulus. When a companion device is in a defined situation, active instructions may enable or activate hardware on the companion device e.g., actuate motors, output audio, display an image on a screen, etc. Some active instructions, may lead to actions performed on devices connected to an external network. Some examples of such actions include but are not limited to printing a ticket at a ticket counter, audio output from the companion device, audio output from an external device, turning on a light emitting diode in the visible or invisible spectrum, enabling a thermal device (e.g. a Peltier device), activating a cooling device, activating a heating device, activating a microphone, sending or triggering a scent, displaying an image on a touchscreen and activating a biometric sensor.

The defined situation may be a user's visit to a webpage, proximity with another companion device, proximity with a wireless access point, proximity to a consumer electronics device, proximity to an entertainment destination, proximity to a particular location at an entertainment destination or a ride at an amusement park, etc. When the companion device is in a defined situation, the companion device may activate at least one set of active instructions. For example, a visit to a webpage may be a visit to a social network profile or theme park's promotional page, which may activate one or more active instructions.

In one or more embodiments, the companion device may display the available active instructions, enabled active instructions or disabled active instructions on a computer. The companion device may display enabled active instructions on a computer interface associated with the computer. The computer interface may be a client side interface to a server.

In one or more embodiments, the defined situation may comprise being located in a political or administrative subdivision such as a region, county, state or country. The defined situation may comprise being present in a retail or wholesale store, e.g. grocery store, theme park, Movie Theater. These locations may be contiguous or otherwise or a combination of different locations.

The defined situation may be the type of user interaction between the user and companion device. For example, if the user squeezes the companion device, this may indicate a defined situation. If the user squeezes the companion device, for a longer period it may indicate a different defined situation. If the user gets into a water body with the companion device, this may signify a defined situation. If the user speaks to the companion device, this may signify a defined situation.

A defined situation may be consumer behavior of the user. For example, consumer behavior may include purchase of products by the user, visits of the user to restaurants, menu items a user selects, purchase or lack thereof of an item a user typically purchases at a location, etc.

A defined situation may be real life achievements. An example real life achievement may be obtaining good grades in school.

A defined situation may be environmental. For instance, a smell or scent may be a defined situation.

A defined situation may be proximity to an entertainment destination, e.g., movie theatre, a home entertainment system, television broadcast, streaming internet video, portable media player and entertainment played from a storage device including but not limited to DVD, Blu-Ray, CD-ROM and SD Card. A defined situation may be before the starting, ending, post-ending or a particular sequence or sequences in a movie shown at an entertainment destination when the companion device is present. A movie may be pre-encoded before distribution. The movie may be dynamically encoded via a network connected to the companion device ecosystem. Alternatively, the companion device, may dynamically obtain instructions, either from the movie itself by or through an external network to which the companion device is connected. The companion device may connect through a mobile device, e.g. a cell phone, to obtain external network access.

The active instructions may play content relating to a movie, when associated with a defined situation at an entertainment destination, e.g. an amusement park, sports arena, restaurant, a retail store providing products or services, theatre, TV show, any physical location where entertainment is provided, any digital source for providing entertainment (e.g. a consumer electronic device), etc. The content may be audio tracks from a movie. In one or more embodiments, the content may be additional content associated with the movie, e.g. original sound track, extended cut scenes, additional voices of favorite characters of the user, etc. The additional content may be an alternate ending. The companion device may be configured to perform other functions not listed herein.

The content may be promotional incentives and may be delivered to an email address associated with the user of said companion device.

In one or more embodiments, the companion device may receive new content on a consumer electronic device subsequent to check-in of the companion device at an entertainment destination. The companion device may obtain promotions subsequent to check-in of the companion device at the entertainment destination promotions via mail or email associated with the companion device. The promotions may be discount offers, accessories for the companion device, added functionality to the companion device, etc.

In one or more embodiments, the user may be sent a certificate of achievement on occurrence of a triggering event; and earn loyalty points based on a number of visits when the companion device is in proximity to the entertainment destination. The loyalty points may grant the user special access at the entertainment destination, for example.

In one or more embodiments, the defined situation may be proximity of companion device to an object, e.g. a second companion device; or proximity to a geographic location. The second companion device may belong to a friend of the first companion device user on a social network.

The companion device may have a stored history of active instructions enabled, disabled, updated or obtained over time.

In one or more embodiments, a defined situation may be a book with an identification chip that enables additional active instructions on the companion device. The book may comprise a chip that identifies when the companion device is in proximity and enables certain functionality on the companion device.

In one or more embodiments, the defined situation may be a board game comprising a chip that identifies when the companion device is in proximity and unlocks active instructions on the companion device. For example, the active instructions may enable additional features (or functions) on the companion device. The defined situation may be an electronic game with encoded cues or game console with an identity chip that enables active instructions when the companion device is in proximity. The electronic game may comprise a chip that identifies when the companion device is in proximity and enables certain functionality on the companion device.

In one or more embodiments, a digital image is captured when the companion device is in proximity to a pre-determined camera.

In one or more embodiments, the companion device may determine a movie start time before activating its active instructions. For instance, the companion device determines a sync point in a movie before activating the active instructions. For example, the companion device may utilize an audio fingerprint to determine a sync point in the movie.

In one or more embodiments, the user may be provided e-commerce functionality for purchasing special merchandise once the companion device comes in the proximity of an entertainment destination.

The presence of the companion device may be used to confirm presence or head count at a physical location. In one or more embodiments, the physical location may be determined using GPS features of the companion device. In one or more embodiments, a GPS radio present in an external device such as a mobile device, laptop or standalone GPS may be utilized.

The defined situation may be interactive inputs from a user on a webpage. When the companion device receives the input from the user, the companion device may enable active instructions on the companion device. For example, if the user visits a webpage and solves a puzzle on the webpage, the webpage may send a message to the companion device to activate active instructions on companion device. In one or more embodiments, the companion device may respond to user input by talking to the user. The companion device may obtain input on real life achievements at a website location. The companion device may be programmed to enable active instructions when the user of the companion device achieves defined goals. The companion device may obtain input on goals and achievement of certain goals by email, text messages, from a webpage or through phone calls or from an app on a phone or software on a computer. For Example, a defined situation may be a goal. A goal in the example may be achieving a specified GPA. Information about the user of the companion device achieving a specified GPA may be sent to the companion device from a smartphone app. In response, the companion device may congratulate the user verbally or unlock active instructions when the user achieves educational goals. The educational goals of the user may also be measured via a testing interface on the companion device.

The companion device may enable active instructions in the proximity of incentive locations. In one or more embodiments, an administrative user may define the incentive locations.

The active instructions may enable messages intended to influence certain behaviors by the user. The messages may be audio messages or video messages. The administrative user may select which of the messages to play.

### BRIEF DESCRIPTION OF THE DRAWINGS

FIG. 1 illustrates an exemplary hardware configuration of a programmed special-purpose computer and peripherals capable of implementing one or more methods, apparatus and/or systems of the present invention.

FIG. 2 is an illustrative example of the systems and environment of the immersive companion device in accordance with one or more embodiments of the present invention.

FIG. 3 is a block diagram representation of an embedded computer system in a companion device in accordance with one or more embodiments of the present invention.

FIG. 4 is an exemplary flowchart for activating features based on a defined situation in the immersive companion device in accordance with one or more embodiments of the present invention.

FIG. 5 is an exemplary flowchart for enabling additional features in the immersive companion device in accordance with one or more embodiments of the present invention.

FIG. 6 is an exemplary flowchart for enabling additional features based on achievement in the immersive companion device in accordance with one or more embodiments of the present invention.

FIG. 7 is an exemplary flowchart of a process for enabling features of the companion device based on proximity to a movie theatre and content of the movie in accordance with one or more embodiments of the present invention.

### DETAILED DESCRIPTION

An immersive companion device responsive to being associated with a defined situation and methods relating to the same will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. Although various examples and embodiments of the invention are set forth in this disclosure, the claims, and the full scope of any equivalents, are what define the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Computer systems and methods disclosed herein provide for a new category of interactive companion device compared to conventional companion devices. One or more embodiments contemplate using one or more devices with actuators and/or transducers as a means to interact with the environment, either separately or in conjunction with pre-existing sensors, networks or computers.

A special-purpose computer as disclosed herein, may be a portable computer, including but not limited to hand-held devices, watches, book-readers, personal data assistants, phones, fitness devices, desktop computer, computer server, virtual machine, cloud server and/or laptop.

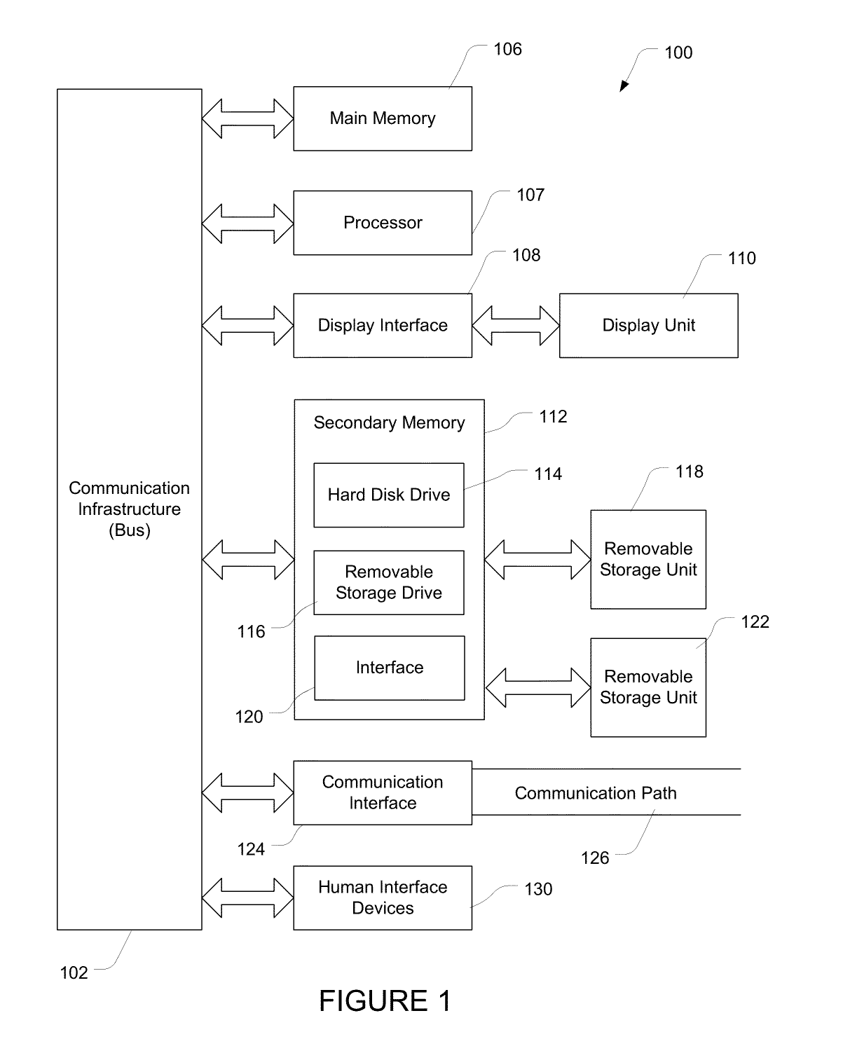

FIG. 1 diagrams a special-purpose computer and peripherals, when programmed as described herein, is capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the special-purpose computer system such as processor 107, main memory 106, display interface 108, secondary memory 112 and/or communication interface 124.

Main memory 106 may provide a computer readable medium for accessing and executing stored data and applications. Display interface 108 may communicate with display unit 110 to display output to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. In one or more embodiments, the system may also encompass parallel systems, multi-processor systems, multi-core processors, and/or any combination thereof. Where a virtual machine, process, device or otherwise performs substantially similarly to that of a physical computer system, such a virtual platform will also fall within the scope of disclosure provided herein, notwithstanding the description herein of a physical system such as that in FIG. 1.

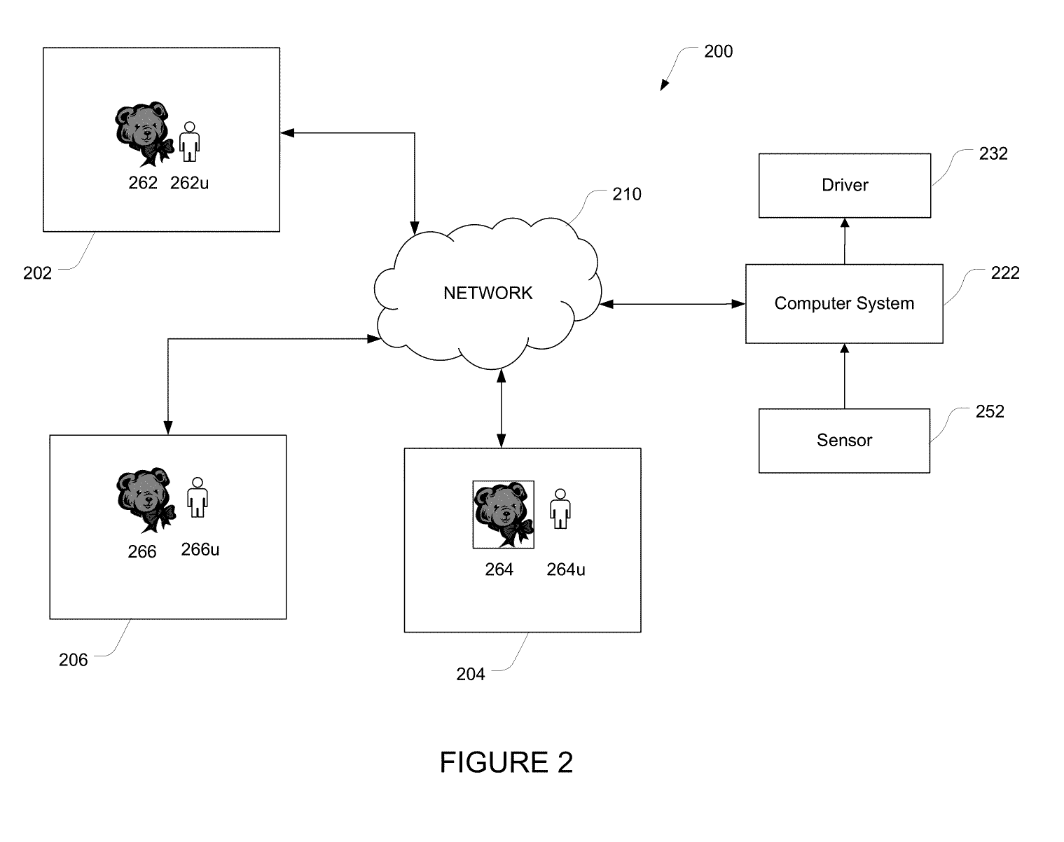

FIG. 2 is an illustrative example of the systems and environment 200 of the immersive companion device in accordance with one or more embodiments of the present invention. As illustrated, environment 200 may include one or more companion devices, e.g. 262, 264, and 266; and one or more Computer Systems, e.g. 222. In one or more embodiments, computer system 222 may comprise special purpose computer 100 (FIG. 1). Each companion device may be associated with one or more users, e.g. 262u, 264u, and 266u. One or more embodiments may have one or more companion devices associated with any one user.

As further illustrated, each companion device may interact with one or more computer systems 222 or other companion devices through network 210. One or more companion devices may be dispersed in the environment at different locations, e.g. 202, 204 and 206. Each location may also include one or more computer system 222 coupled to the network 210. The network 210 may be any communication network, e.g. wireless, cellular, terrestrial, Wi-Fi, Bluetooth, wired, etc. Each Computer 222 may also be connected to one or more sensors, e.g. 252. Sensor 252 may be any device, e.g. a transducer, configured to detect one or more companion devices in its vicinity and convey that information to computer 222. For example, sensor 252 may be an RFID reader, a code reader, or any other form of identification system.

Each computer 222 may also be connected to one or more Drivers, e.g. 232. Driver 232 may be configured to create a certain effect in the environment. For instance, Driver 232 may cause lighting change in the location or environment, create some form of announcement, drive external peripherals, etc.

Those of skill in the arts would appreciate that, although the representation of the system and environment 200 shows specific number of locations, computers, sensors, and drivers, other arrangements are possible and may be suitable for a given application. For example, a system with just one location 202 may be suitable for an exclusive event with specially designed interactive companion device for use only during the exclusive event.

In one or more embodiments, an interactive companion device, e.g. 262, may have internal sensors for sensing the location and may communicate directly with a Global Positioning System to determine location and activate features even in the absence of a computer at a location. In this case, the computer may be located in space and not at the location where the companion device is present. This example may require access to the network 210 or may be independent of the network 210. Also, it should be understood that there may be multiple computers at any one location. Additionally, there may be more than one network, which may interface with all components of the system and environment 200 or sub-components of the system and environment.

In one or more embodiments, there may be one or more companion devices present in multiple locations and the companion devices may be activated simultaneously. This may be termed as one to many occurrences. For example, where there may be an event at a theme park in Los Angeles at 1 PM and the same event may occur simultaneously at a theme park in Florida. In a further example, an NFL half-time-show may trigger many companion devices in multiple sports bars, homes or other destinations.

In one or more embodiments of the present invention, companion device, e.g. 262, comprises a shell body and one or more embedded computer systems to enable the features described herein. The shell body, for example, could be a teddy bear, other types of stuffed animals, dolls, toys, or any other form of companion devices commonly used by individuals.

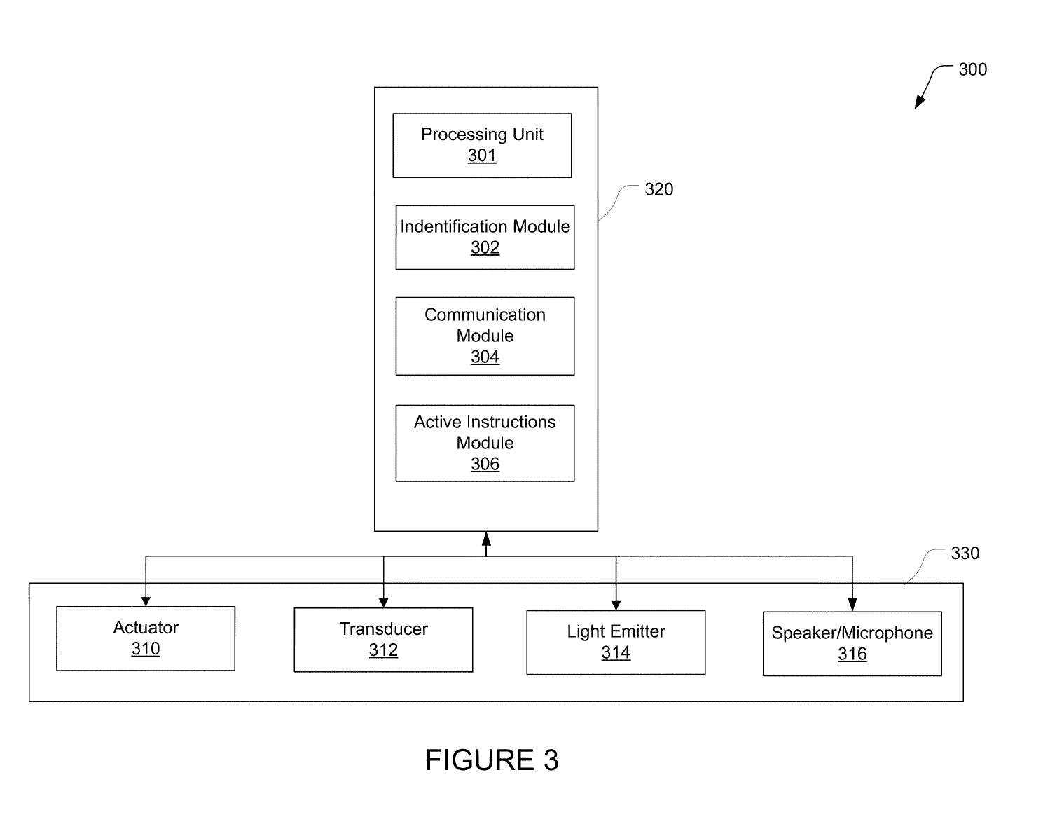

FIG. 3 is a block diagram representation of an embedded computer system 300 in a companion device in accordance with one or more embodiments of the present invention. As illustrated, the embedded computer system 300 comprises embedded computer 320 and one or more human interface/feedback devices 330, e.g. actuator 310, Transducer 312, Light Emitter 314, and Speaker/Microphone 316. The human interface/feedback devices 330 may be internal or external to the embedded computer system or a combination of external and internal circuits in the embedded computer system. The embedded computer system 300 comprises at least one processing unit 301; and an identification module 302 that provides at least one unique identifier, e.g. an email address, a serial number, a social media profile, a social media login, a network address etc. In one or more embodiments, the companion device, e.g. 262, may have a user profile, which in turn contains an email address or an online social network profile. The identification module 302, in one or more embodiments, may be a near field identification device.

The companion device, e.g. 262, may have an external memory device, or internal memory, which may be distinct from embedded computer system 300 for storing the aforesaid unique identifier, social media profile, email address, network address, serial number or other information associated with companion device. The unique identifier of the companion device, e.g. 262, may identify one or more defined situations and responses to defined situations, e.g. enable active instructions 306. A companion device, e.g. 262, may identify its location using internal sensors, e.g. transducer 312. In one or more embodiments, computer 222 may identify the companion device, e.g. 262, using the unique identifier. For example, a computer 222 at a theme park may identify companion device, e.g. 262, based on information in the identification module 302.

For example, if a defined situation is presence of a companion device, e.g. 262, at a theme park, then the companion device, e.g. 262, is in proximity to the defined situation when it is present at the theme park. The unique-identifier, may be sensed by a computer 222 at the location to identify presence at the defined situation, e.g. location, and may result in enabling active instructions 306, which may be specific to the defined situation for a specific companion device, e.g. 262. The defined situation, may just be the location, or may include additional parameters such as time in the location, or taking a joy ride at the location. It should be understood, that multiple variations of defined situations are possible, some of which are set forth as exemplary, and not as exhaustive embodiments. It is contemplated that there are numerous defined situations, and it is intended that all such defined situations are part of this invention.

In one or more embodiments, the companion device, e.g. 262, may act as a passive device. The embedded computer system 300 may be used to store at least one unique identifier in a passive device, e.g. identification module 302 may be passive, and all actions may be performed external to the companion device, e.g. by Computer 222. The companion device, e.g. 262, may have at least one unique identifier, which may be permanent. For example, the unique identifier could be stored in an RFID chip. The RFID embedded chip may be active or passive. The RFID Chip may interface with at least one external computer 222. The computer 222 may sense the embedded computer system 300 and enable a set of active instructions 306 in the embedded device 300. In one or more embodiments the active instructions may use the Driver 232 attached to at least one external computer 222. For example, the active instructions 306 may activate a program on an external computer 222 such as a server computer at a ticket counter or kiosk, tablet, phone, consumer electronics device, etc. The active instructions 306 may be active code segments or dormant code segments. One or more of these active instructions 306, may be run later, instead of when they are enabled.

The active instructions 306 may be activated when the companion device, e.g. 262, is at location 202. Location 202 may be part of a pre-defined situation, which activates additional features to be performed by the embedded computer system 300. Additional features may be performed by integrated circuits in the embedded computer system 300 when it is associated with a defined situation such as proximity to location 202, the frequency of proximity to location 202, user behavior as tracked by companion device, e.g. 262, consumer use of the companion device, e.g. 262, real life achievements of the user such as good grades. Exemplary real life achievements may include birthday, bike ride, hiking, swimming milestone, reading books, completing school work, completing puzzles, completing math problems or science problems, completing a written article, art achievements, karate, soccer, a user-defined or specific goal in any of these areas, scoring a goal in a game or a combination of these. The location 202 may be any entertainment destination. Exemplary locations 202 may include movie theaters, theaters, theme parks, specific screens in multiplexes, specific parts of a movie, music concerts, parks, zoos, restaurants, retail store providing products or services, TV shows, specific parts of TV shows, cartoon shows, craft shows on TV, specific parts of TV shows, a physical location, a website or network address location when visited by a user, digital source for providing entertainment, audio or video streaming service, a geographic location, a party including but not limited to birthday parties, class excursions, class visits, network location of a social media page, proximity to a camera, proximity to a wireless access point, etc. In one or more embodiments the geographic location may be a state, a country, a region or a subsection of such or a combination thereof.

In one or more embodiments of the invention the at least one external computer 222 may be connected to at least one circuit board 232. The unique identifier 302 and communication module 304 may be internal to the embedded computer system 300 or external to the embedded computer system 300. A communication module 304 may be present on the embedded computer system 300. A human interface/feedback device 330 may, as shown in FIG. 3, be embedded in the embedded computer system 300 or may be a separate module connected to the embedded computer system 300 or may be combination with some parts internal to the embedded computer system 300 and others external to the embedded computer system 300.

In an exemplary embodiment human interface/feedback device 330 may contain at least one actuator 310. As used herein an actuator 310 may be a type of motor for moving or controlling a mechanism or system. It may cause vibratory motions, linear or rotary motions. It may be operated by a source of energy including but not limited to electric current, hydraulic fluid, pneumatic pressure, heat, light, electromagnetic spectrum, radiation and converts that energy into motion. As used herein an actuator 310 may also be a mechanism by which a control system acts upon an environment. The control system may be a mechanical system or an electronic system or software based. Actuator 310, by way of example and not limitation, may be hydraulic actuators, pneumatic actuators, electric actuators and mechanical actuators. Actuator 310 may be Electric motors, pneumatic actuators, hydraulic pistons, relays, comb drives, piezoelectric actuators, thermal bimorphs, digital micro-mirror devices and electro-active polymers. For example, an actuator 310 may be an electric motor configured to move parts of the companion device or to move the entire companion device, e.g. 262, relative to its initial position. In companion device, e.g. 262, an electric motor with circular motion may be used for linear applications by connecting the motor to a lead screw or such other mechanism.

In another exemplary embodiment the human interface/feedback device 330 may contain at least one transducer 312. A transducer 312 may be an electroacoustic transducer that produces sound in response to an electrical signal input. Transducer 312 may include but is not limited to, horn loudspeakers, piezoelectric speakers, magnetostrictive speakers, electrostatic speakers, ribbon and planar magnetic loudspeakers, bending wave loudspeakers, flat panel loudspeakers, heil air motion transducers, plasma arc speakers, digital speakers, transparent ionic conduction speaker and thermo-acoustic speakers. As an example and not by means of limitation, a transducer may be thermoacoustic and embedded into a silicon semiconductor. The transducer 312 may be a bone conduction speaker. The companion device, e.g. 262, may have at least one of active instructions 306 including, for example, an instruction to enable audio output from the companion device, e.g. 262.

The transducer 312 may be a microphone or the human interface/feedback device 330 may contain a Speaker/Microphone 316. Exemplary but not limiting types of microphones are condenser microphone, dynamic microphone, ribbon microphone, carbon microphone, piezo-electric microphone, fiber-optic microphone, laser microphone, liquid microphone, MEMS, microphone and speakers used as microphones. In one or more embodiments companion device, e.g. 262, may have at least one microphone. The companion device, e.g. 262, may have a microphone array. The companion device, e.g. 262, may have a loudspeaker and microphone combination, e.g. 316, to reduce the number of active components. For example, the companion device, e.g. 262, may have two or more microphones to enable processing of the received audio signals to determine the direction of the audio signal, differentiate different sources of the signal, noise reduction or to enable the companion device, e.g. 262, to digitally process the signal.

The human interface/feedback device 330 may contain at least one transducer 312, which is an electro-optical or photoelectric transducer. Electro-optical or photoelectric transducers include but are not limited to fluorescent lamp, incandescent lamp, light-emitting diode, laser diode, photodiode, photoresistor, phototransistor, photomultiplier, photodetector, light dependent resistor and cathode ray tube. For example, a companion device, e.g. 262, could have one or more light emitting diodes to enable illumination of the companion device. The companion device, e.g. 262, may have active instructions to enable lights on the companion device to illuminate.

In yet another exemplary embodiment, the human interface/feedback device 330 may contain at least one transducer 312, which is a thermoelectric transducer. A thermoelectric transducer includes but is not limited to restive or joule heater, radiative heater, thin-film technology, resistance temperature detector, thermocouple, Peltier cooler, thermistor and thermopile. For example, a companion device, e.g. 262, could have a transducer 312 which contains at least one Peltier cooler or solid state refrigerator. The companion device, e.g. 262, may have at least one active instruction to enable a temperature device such as transducer 312, including but not limited to a Peltier cooler, on the companion device, e.g. 262.

The human interface/feedback device 330 may contain at least one transducer 312, which is Electromechanical. Examples of electromechanical transducers include but are not limited to electroactive polymers, galvanometer, microelectromechanical systems, rotary motor, linear motor, vibration powered generator, potentiometer for position sensing, linear variable differential transformer, rotary variable differential transformer, load cells, accelerometer, strain gauge, string potentiometer, air flow sensor and tactile sensor.

The human interface/feedback device 330 may contain at least one transducer 312, which is electrochemical. Examples of such a transducer 312, includes but is not limited to pH probe, electro-galvanic fuel cell, hydrogen sensor. The human interface/feedback device 330 may contain at least one transducer 312 which is electromagnetic. An electromagnetic transducer 312 includes but is not limited to an antenna, magnetic cartridge, tape head, read- and write-head, hall-effect sensor etc. In another exemplary embodiment the human interface/feedback device 330 may contain at least one transducer 312 which is a radio-acoustic transducer. Examples of radio-acoustic transducer 312 includes but is not limited to radio receivers, radio transmitter which propagates electromagnetic transmissions to sound and Geiger-Muller tube.

The transducers listed above are merely examples. There are other transducers which are known in the art and one or more embodiments of the companion device, e.g. 262, may use such other transducers.

The human interface/feedback device 330 may contain at least one display, e.g. 314, such as liquid crystal display, light emitting diode display or electronic ink display. The display, e.g. 314, may be used to communicate with the user. For example, the display may be used to display directions or instructions during treasure hunts at defined locations. The display may be used to provide promotion codes. The display may be used to provide additional content at movies. The companion device, e.g. 262, may use human interface/feedback device 330 to display a computer interface with set of active instructions enabled on the embedded computer system 300. In one or more embodiments, the computer interface is a client side interface to a server. For example, at least one or more computers may be connected to embedded computer system 300 such as computer 222, which may be the server. The computer interface on the embedded computer system 300 retrieves such information from computer 222 and displays the same on the display 314.

In one or more embodiments, the unique identifier of companion device, e.g. 262, and a list of active instructions enabled or disabled or a combination of both may be backed up on a computer. Information in the embedded computer system 300 may be moved from one companion device, e.g. 262, to another, for example, in case the original companion device is damaged, replaced or upgraded. The transfer of unique identifier of companion device, e.g. 262, may be achieved by means of a memory storage device, such as a flash memory card or a secured digital (SD) memory card. In one or more embodiments, companion device, e.g. 262, which is physically damaged, or malfunctioning, or one in pristine condition or any other condition being replaced for any reason, may be brought close to a new companion device giving life to the new companion device.

The companion device, e.g. 262, may activate at least one active instruction when the defined situation is a location, e.g. 204, such as the user visiting a web address or a network address. A defined situation may be proximity to another companion device, e.g. 264, proximity to a consumer electronics device, proximity to a wireless access point, proximity to an entertainment destination, proximity to an amusement park, proximity to a pre-determined object, proximity to a geographic location, proximity to an incentive location, proximity to a pre-determined camera, proximity to entertainment destination such as theatre, movie hall, a certain part of the movie, a theme park, digital source for providing entertainment, TV show, DVD movie, proximity to a camera, etc. As used herein, the location 204 may be a physical location or a virtual location, location on a network including but not limited to the internet, etc.

For example, the companion device, e.g. 264, may be provided with a set puzzle, which when solved reveals a unique uniform resource locator (“URL”) address or network address. When the user, e.g. 264u, visits the webpage, the companion device, e.g. 264, updates the active instructions 306 or enables dormant active instructions 306. In yet another example, TV advertisements might promote certain products and encourage the user 264u to visit a location 204 which may be a URL. When the user 264u then visits the location 204, which may be a URL of a webpage, certain active instructions 306 may be updated to the companion device or dormant active instructions 306 may be enabled.

The companion device, e.g. 264, may activate at least one of the active instructions 306 where the defined situation is location 204, which may be proximity to at least one other companion device, e.g. 262. For example, when companion device, e.g. 262, meets another companion device, e.g. 264, it might activate active instructions 306 in companion device 264, which greets the other companion device 262, or user 262u of the other companion device, e.g. 262. In one or more embodiments, the active instructions 306 may be activated only when the companion device, e.g. 262, is in proximity with another companion device, e.g. 264, which has similar enabled active instructions 306. In one or more embodiments companion device, e.g. 262, may activate such active instructions 306 only when such greetings are permitted by a parent or administrator of the user 262u.

The companion device, e.g. 262, may activate at least one active instruction when the defined situation is location 202 which may be proximity to a wireless access point. For example, companion device, e.g. 262, may activate active instruction 306 when the companion device, e.g. 262, reads an SSID of a wireless access point. At location 202, the wireless access point may be configured to send out an unlock code to one or more companion device, e.g. 262, when the companion device is in proximity to the access point.

In one or more embodiments the additional features may be activating a thermoelectric transducer which results in heating or cooling of the companion device, e.g. 262, or a part of the companion device. Additional features may also be activating a color changing fabric. The color changing fabric may be a thermochromic fabric or a light sensitive fabric, or fabric which is responsive and transmits different colored illumination to create the impression of change in color.

In one or more embodiments the additional features may be activating a brain computer interface which enables a companion device to read emotions and thoughts of the user. For example, any of the brain computer interfaces, including but not limited to EEG and EKG, may be used to communicate with the companion device to enable active instructions 306.

In one or more embodiments, the companion device, e.g. 266, may activate at least one active instruction when the defined situation is location 206, which may be proximity to a consumer electronics device. For example, companion device, e.g. 266, may activate at least one active instruction 306 when the companion device, e.g. 266, is at location 206, which may be proximity to a home entertainment device. Companion device, e.g. 266, may activate at least one active instruction 306 when the companion device, e.g. 266, is in proximity to location 206, which may be a dangerous zone such as a road or outer door of a house.

In one or more embodiments, a companion device, e.g. 262, may activate at least one active instruction 306 when the defined situation is location 202, which may be an entertainment destination, and at least one of said set of active instructions 306 is initiated once the companion device, e.g. 262, comes in proximity to any sort of entertainment destination. For example, the companion device, e.g. 262, may activate at least one active instruction 306 when the defined situation is a location 202 which may be an entertainment destination such as a theme park. The companion device, e.g. 262, may enable at least one active instruction 306 when the defined situation is location 202 which may be an entertainment destination such as a defined movie theatre. In another example, the companion device, e.g. 262, may activate at least one active instruction 306 when the location 202 is an entertainment destination such as a defined restaurant. The companion device, e.g. 262, may activate at least one active instruction 306 when the defined situation is a location 202 is an entertainment destination such as a specific park.

In one or more embodiments, the companion device, e.g. 262, activates at least one active instruction 306 when the defined situation is achievements of the user. The achievements of the user may be achievements based on visiting a location 202 such as a restaurant, park, theatre, theme park, retail outlet or such other physical locations. In one or more embodiments of the invention the achievements of the user 262u may be linked to how a user uses a consumer electronics device as tracked by the companion device, e.g. 262. For example, achievements of the user of companion device, e.g. 262, may be unlocked when the user 262u has read a nursery rhyme or seen a nursery rhyme on TV. The achievements of the user 262u may be linked to actions the user takes online. For example, awards or credits earned during gameplay may result in an achievement. The achievements of the user 262u may be linked to consumer behavior. For example, achievements of the user 262u may be linked to how the user shops or the products he/she shops for. The achievements of a user 262u may be linked to products the user frequently purchases. Achievements of a user 262u may be linked to performance in school such as good grades, extracurricular activities in school, sports achievements, etc. The achievements may be tracked when the user 262u or parent of user 262u visits a location 202 which may be a URL or network address and updates the details of user 262u.

The defined situation may be location 206, e.g. an entertainment destination such a movie theatre. The location 206 may enable at least one of the set of active instructions 306 when the location 206 includes a specific screen where a movie is shown at the movie theatre. The defined situation at location 206 may enable at least one of the set of active instructions 306 which may be audio content relating to the movie. For example, companion device, e.g. 266, may have active instructions 306 which are updated when the companion device, e.g. 266, is at a movie theatre. The companion device, e.g. 266, may then execute the active instructions upon request by the user. The companion device, e.g. 266, in this case may have a human interface/feedback device 330 with a loudspeaker 316. At least one computer 222 may be a tablet or a phone or a consumer electronics device. The active instructions 306 may be audio content such as audio tracks from the movie. The active instructions 306 may be additional content associated with the movie such as original sound tracks, alternative ending, extra features, extra scenes, behind the scenes content etc. In one or more embodiments the active instruction 306 may result in additional content such as an alternative ending being made available to the owner of companion device, e.g. 266, via a distribution mechanism such as a network or otherwise. The additional content may be sent to an email address associated with the user 266u of the companion device, e.g. 266. In another example, the companion device, e.g. 266, may active instructions, which may result in the companion device illuminating, vibrating, heating or cooling at least a part of the companion device.

The companion device, e.g. 262, may work with movies and TV shows on television or played through a DVD player, TV, Blue-ray, streaming device, gaming consoles or any other source of entertainment, such a portable computers including laptops, tablets, mobile phones, video game players, book readers, or desktop computers. In one or more embodiments, the companion device, e.g. 262, may interact with locations on games of game consoles, locations in movies and such other locations, when in proximity to the entertainment device. In accordance with this interaction, the companion device, e.g. 262, may illuminate, vibrate, heat, cool, produce audio output, or combinations thereof.

The companion device, e.g. 262, may receive active instructions 306, which may be additional content such as promotional incentives. The location 202 may be an entertainment destination such an amusement park. The companion device, e.g. 262, may then enable at least one of the set of instructions when the companion device, e.g. 262, is in proximity to a location at the amusement park. Such location could be granular and the companion device, e.g. 262, may receive additional active instructions 306 or activate active instructions 306 only at specific locations in an amusement park. For example, only new rides at the amusement park may be promoted and the active instructions 306 may activate only at the new ride and not in other locations. The reverse may also be true where an old ride may be promoted when the capacity at the new ride requires balancing of load by attracting more people to old rides.

The location 202 may be an entertainment destination such as a sports arena. For example, the companion device, e.g. 262, may activate at least one active instruction 306 when the favorite team or player of user 262u achieves an advantage or is at a disadvantage or the game is at a stalemate or stagnant. For example, the companion device, e.g. 262, may activate active instructions when a goal is scored in a football game or a homerun is hit during a baseball game by the favorite team of the user 262u. In reverse when a goal is scored against the favorite team of the user 262u the companion device, e.g. 262, may activate active instructions 306, which may encourage the team. The companion device, e.g. 262, may enable active instructions 306 to keep user 262u entertained when there is a lull in the gameplay.

The location 202 may be an entertainment destination such as a restaurant. There may be promotions for extra food, special discounts or a gift when a user 262u visits a restaurant. The user 262u may receive gifts for visiting the restaurant. The user 262u may be eligible for bigger rewards based on the frequency of visits within a set duration.

The location 202 may be an entertainment destination such as a retail store providing products or services. For example, there may be a promotion at a retail store by a manufacturer with or without the endorsement of the retail store. The promotion may lead the user 262u to identified products such as books, school supplies, other companion device, etc., which the user 262u may be interested in obtaining. Similarly, the retail store may run promotions, which target the user 262u.

The location 202 may be an entertainment destination such as a theatre. For example, there may be a promotion for a play at a theatre targeting children including user 262u. The user 262u may be called onto the stage during a magic show. The user 262u may have special backdoor access during a play or a magic show to meet the stars.

The location 202 may be an entertainment destination such as a TV show. For example, the TV show may be a morning show with puppets. The user 262u may activate active instructions 306 which makes the companion device, e.g. 262, sing along with the content on the television show. The companion device, e.g. 262, may activate active instructions 306 which encourage the user 262u to dance or move as instructed by the TV show.

The location 202 may be entertainment destination, which is any physical location where entrainment is provided. In one or more embodiments of the invention the entertainment destination is any digital source for providing entertainment. The digital source may be a consumer electronic device.

In one or more embodiments, subsequent to check-in of the companion device, e.g. 262, at a location 202, such as the entertainment destination, new content is given to the companion device. For example, subsequent to check-in of the companion device, e.g. 262, at a music concert the companion device 262 may be updated with active instructions 306. The companion device, e.g. 262, may be given active instructions 306 when visiting a location 202 such as a movie theatre to play in sync with the movie being played. Subsequent to check-in of the companion device, e.g. 262, at the location 202, such as an entertainment destination, promotions are offered to the user 262u via mail or email. The promotions may be discount offers. The promotions may be accessories or components for the companion device, e.g. 262. The promotions may be added functionality for the companion device, e.g. 262. For example, the companion device, e.g. 262, may be given the functionality to wake up the user 262u every day in the morning. In one or more embodiments, the user 262u is sent a certificate of achievement on occurrence of a triggering event. The triggering event could be an achievement in a game or in real life. For example, good grades might be a triggering event. The user 262u earns loyalty points based on a number of visits when the companion device 262 is in proximity to location 202 such as the entertainment destination. The loyalty points may grant the user 262u special access at the entertainment destination.

In one or more embodiments, the location 202 may be a website virtual world. For example, location 202 may be website virtual world to interact with or create companion device, e.g. 262. The users of the virtual world may interact with the virtual world to create objects in the virtual world such as animals or airplanes or any other object in the virtual world or they may interact with the virtual world with pre-existing virtual objects. For example, the virtual world may contain Muppets from the television series Sesame Street. The companion device, e.g. 262, or multiple companion devices may be physical representations of the virtual world objects. The companion device may activate one or more active instructions 306. For example, the active instructions 306 may result in illumination of one or more physical companion device, when the companion devices get close to their friends in the game. This may be either virtual closeness as defined in the virtual world or closeness of their creation to the physical companion device. The user of the companion device, e.g. 262, may have a playdate with another visitor user of a visitor companion device, e.g. 264, who may bring in visitor companion device or companion device 264. In one or more embodiments, if the visitor companion device, e.g. 264, is identical or similar to the companion device of the user, the physical companion device, when they interact with each other may create activate one or more active instructions 306. The additional active instructions 306 may include achievements on the virtual world such as best friends forever badges in the virtual world. These interactions in one or more embodiments may be limited to similar companion devices or identical companion devices.

In one or more embodiments, the location 202 may be a virtual destination in a video game, on any entertainment medium including but not limited to hand-held games, tablet, phone, laptop, computer, smart TV, streaming device, interactive companion device or such other devices used for gaming. In one or more embodiments, when the user of the companion device, e.g. 262, achieves actions such as clears a level in the game, finds a secret location, or artifact in the game, scrolls over a hidden location on the screen, the companion device may enable active instructions 306. The, active instructions 306, may enable illumination, vibration, cooling, heating or a combination thereof of the companion device.

In one or more embodiments, the location 202 may be a method of travel. Method of travel includes but is not limited to companion device on plane, train, automobile, boat, cruise, subway, bus, bike, scooter, skateboard, roller blades, motorcycle, helicopter, spacecraft, satellite or any other form of transportation. Companion device, e.g. 262, may enable active instruction 306 when associated with this location 202.

In one or more embodiments, the location 202 may be a national park. For example, the companion device, e.g. 262, may enable active instruction 306 when associated with this location 202. The national park may be Yosemite, Yellowstone, Denali, or such other national parks. For example, the companion device, e.g. 262, could be Smokey the bear or other companion device and user can select this theme while buying the companion device or associating the companion device, e.g. 262, with a user profile. In one or more embodiments, the companion device, e.g. 262, may enable active instruction 306 when associated with a shopping mall, theater, grocery store, school, park and pool, etc.

In one or more embodiments, the location 202 may be a sports venue such as a basketball arena, baseball arena, football stadium, soccer stadium, racetrack or such other sports venue. The location 202 may be a subsection of the sports venue, such as Dodger stadium, Angel stadium, Giants stadium or such other single venue sport stadium. The companion device, e.g. 262, may enable active instructions 306 when associated with such location.

In one or more embodiments, the active instructions 306 may be achievements. Achievements may be generic or branded. For example, branded achievements may be linked to visiting branded locations 202 such as Disneyland (original), Disney cruise, Disney Resort, Disneyworld, Disneyland Europe, Disney themed play, Disney movie, Disney TV show, Disney game on a game console, Disney book, Disney retail store and Disney website. There may be additional companion device for each sub-brand or for different brands. One or more of these companion devices, may help the user achieve a specific achievement in one of the locations or multiple locations. For example, a companion device branded with Mickey Mouse may only enable achievements related to Mickey Mouse when visiting Disneyland. For example, within a Disney theme park location 202, companion device, e.g. 262, may enable one or more active instructions 306 when a Disney cast member autographs a card, on specific rides in the park, at certain stores in the park, at certain restaurants in the park, during a parade, during a world of color, when in frontier land, when visiting fantasy land, when visiting tomorrow land, main street, Disney train, monorail or a combination thereof.

In one or more embodiments active instructions 306 may be activated on vacation in presence of the companion device, e.g. 262, when the activity is to take pictures at a specific location, camping at a specific location, eat dinner at a specific location, eat breakfast at a specific location, swim at a specific location, going to beach at a specific location, horseback ride at a specific location, play Frisbee at a specific location, seeing movies at a specific location, etc.

In one or more embodiments, the companion device, e.g. 262, may activate instructions, which allow the user to obtain, free real world products or services. These may be enabled by enabling active instructions 306, which communicate with other computers or devices proximate to the companion device. An exemplary list of such products or services includes, free food, additional functionality, free trips, free tokens online, discounts, advance to front of line once, advance to the front of the line for an hour, advance to the front of the line for the whole day, etc.

The active instructions 306 for additional features may be activated when the companion device, e.g. 262, is in proximity to a pre-determined object. For example, the active instructions 306 may activate when the companion device is in proximity to a camera at location 420 which results in a picture with user 262u with the companion device, e.g. 262, executing active instructions. The picture may then be mailed to user 262u or shared with the user 262u over a network. The active instructions 306 for additional features may activate when the companion device, e.g. 262, is in proximity to a geographic location.

The additional features may be activated when the companion device, e.g. 262, is in proximity to a second companion device, e.g. 264. The second companion device, e.g. 264, may need to be a friend of user 262u on a social network for additional features to be activated by companion device. Companion device, e.g. 262, may have storage of history of the additional features obtained over time. The history of additional features may be dynamically swapped as and when location 202 changes by retrieving the instructions from computer 222.

In one or more embodiments location 202 may be a book, which includes a chip that identifies when the companion device 262 is in proximity and unlocks additional features on the companion device. In one or more embodiments, the book may contain an identification system (e.g. a chip) that identifies when the companion device, e.g. 262, is in proximity and enables certain functionality on the companion device, unlocks certain features in the book, etc. In one or more embodiments, when the companion device is in proximity to the book, certain features are unlocked and available to the reader. The removal of the companion device(s) may optionally disable the features, which were unlocked. In one or more embodiments, the active instructions 306 may be enabled using a code which is present in a physical book or kindle book, which activates additional features, or may be based on questions, which the user of companion device, e.g. 262, will know based on the contents of the book. The code may be entered into a website linked with the companion device or on the companion device.

The location 202 may be a board game, which includes a chip that identifies when the companion device, e.g. 262, is in proximity and unlocks additional features on the companion device, e.g. 262. The location 202 may be a board game, which includes a chip that identifies when the companion device, e.g. 262, is in proximity and enables certain functionality on the companion device, e.g. 262. The identification may be by the companion device, e.g. 262, or the board game or by both the game and the companion device, e.g. 262. The location 202 may be an electronic game, which has an identification system (e.g. a chip) that identifies when the companion device, e.g. 262, is in proximity and unlocks additional features using active instructions 306 on the companion device. The companion device may enable certain functionality on the companion device; enable certain functionality in the game, etc. Conversely, in one or more embodiments, the proximity to the location 202 may unlock or enable additional features on the board game or the electronic game as the case maybe. In one or more embodiments, the location 202 may be an interactive educational game or educational sites such as elementary school, middle school, high school, or college.

The location 202 may be a proximity to a pre-determined camera which results in a digital image capture. The companion device, e.g. 262, may determine a movie start time before activating additional instructions 306 which results in additional features. The companion device, e.g. 262, may determine a location 202 which may be a sync point in a movie before activating the additional features. The companion device, e.g. 262, may utilize an audio fingerprint to determine a sync point in the movie. In one or more embodiments the user 262u is given e-commerce functionality to purchase special merchandise once the companion device, e.g. 262, comes in proximity with a location 202 such an entertainment destination. For example, there may be special merchandise on sale at a retail location or an entertainment destination which may only be purchased by a user 262u with a companion device, e.g. 262. A special commemorative movie memorabilia may only be available to the user 262u with such a companion device, e.g. 262. The companion device, e.g. 262, may connect to a mobile device to obtain network access 210. In one or more embodiments, the presence of the companion device confirms attendance at a physical location using GPS features of the mobile device associated with the companion device or a GPS present in companion device.

In one or more embodiments, further input may be obtained from a user 262u at location 202, which may be a website location, and the companion device, e.g. 262, responds based on the user input at the website location. Activity of the user 262u at location 202 such as a website location or a network location may result in the companion device, e.g. 262, providing a response based on certain user activity on website location. For example, when the user 262u visits certain specified educational websites the companion device, e.g. 262, may activate additional active instructions.

In one or more embodiments, input may be obtained from a user 262u at a location 202 such as website location, achievements may be granted to the user 262u based on the input and the companion device, e.g. 262, may be caused to give a response based on the achievements. The companion device, e.g. 262, may activate active instructions 306 when in proximity to an incentive location 202. The incentive location 202 may be locations, which are defined by an administrative user. For example, the administrative user may be a parent of user, e.g. 262u, or a third party advertiser or promoter or the manufacturer of the companion device or agent appointed by the manufacturer of the companion device. The active instructions 306 may be additional features or may contain audio messages intended to influence certain behaviors by the user. The administrative user may be allowed to select which of the audio messages to play. In one or more embodiments, based on behavior the user of companion device, e.g. 262, may be provided with free products or services.

The companion device, e.g. 262, performs at least one of the active instructions 306 which may be additional features when educational achievements are obtained. The educational achievements of the user 262u may be measured via a testing interface.

In one or more embodiments an immersive companion device, e.g. 262, responsive to being associated with a defined situation consists of at least one embedded computer system 300. The at least one embedded computer system 300 further comprises one or more processing units 301, at least one Identification module 302, a communication module 304 configured to communicate with a network, and active instructions set 306. In one or more embodiments, at least one computer 222 is configured to communicate with the at least one embedded computer system 300 to determine proximity to a defined situation such as location 202 and at least one human interface/feedback devices 330 coupled to the embedded computer system 300 configured to enable active instructions 306 such as additional features to be performed when the embedded computer system 300 is associated with a defined situation such as location 202. In one or more embodiments an immersive companion device, e.g. 262, further has a unique identifier that may be a unique user profile associated with the user, e.g. 262u.

In one or more embodiments, the profile may be managed online. In addition, the achievements, active instructions 306, which are enabled, goals for the user, achievements on brands, other type of real world events, books, real world goals, etc. may be updated online. The online profile of the companion device, e.g. 262, may automatically sync and updated. This feature enables seamless replacement of a damaged or stolen companion device. A stolen companion device, e.g. 262, may thus be inactivated using the online profile. Using the online profile users of companion device, e.g. 262, can customize profiles, limit, set or make goals for their achievements to brands, e.g. Disney, or other types of achievements. For example, when user and Companion Device achieve destinations, events such as book reading, games, visiting websites, the companion device, e.g. 262, syncs with network, either immediately or at a later time and updates profile and shows that user of companion device has made such achievements online. The companion device, e.g. 262, syncs the online profile and companion device profile to obtain further updates or updates to active instructions 306.

In one or more embodiments an immersive companion device, e.g. 262, which is responsive to being associated with a defined situation such as location 202, has at least one embedded computer system 300. The at least one embedded computer system 300 further has a Identification module 302 and a communication interface 304. In one or more embodiments, at least one computer 222 is configured to communicate with the at least one embedded computer system 300 to determine proximity to a defined situation such as location 202, the embedded computer further comprises a set of active instructions 306 and at least one human interface/feedback device 330 coupled to the at least one embedded computer 320 configured to enable additional features using active instructions 306 to be performed when the embedded computer system 300 is associated with the defined situation.

The additional features of the companion device, e.g. 262, may include using human interface/feedback device 330 with actuators to enable movement of part of the companion device or movement of the companion device relative to the ground. In one or more embodiments, the additional features of the companion device, e.g. 262, may include enabling audio output from the companion device using human interface/feedback device 330 with an electroacoustic transducer such as a loud speaker. In one or more embodiments, the additional features of the companion device, e.g. 262, may include instruction to enable lights to illuminate on the companion device. The additional features of the companion device, e.g. 262, may include instructions related to audio content associated with a movie. The additional features of the companion device, e.g. 262, may include instruction may be audio tracks from the movie being shown at the movie hall where the companion device, e.g. 262, is present. The additional features of the companion device, e.g. 262, may be an alternative ending. The additional features of the companion device, e.g. 262, may be activated when a specific content or program is played on the television. The additional features of the companion device, e.g. 262, may be activated when a specific program is played using a video player such as a DVD player, a Blu-ray player, any player with a permanent or removable storage. Or any other output device, e.g. receiver, Apple TV, etc.

The additional content may be promotional incentives. The additional content may be delivered to the email address associated with the companion device. The additional content may be promotions delivered after the companion device, e.g. 262, has reached a defined situation. The additional content may be discount offers sent to the user 262u of companion device, e.g. 262. In one or more embodiments the additional content may be accessories for the companion device, e.g. 262. The additional content for companion device, e.g. 262, may be added functionality such as ability to repeat words or spontaneously repeat certain instructions. The additional content may be achievement of a triggering event such reinforcement of good behavior pattern for a user 262u. The addition content may be a certificate of achievement which is sent to the user by electronic mail or by regular mail when certain a triggering event occurs. A triggering event for companion device, e.g. 262, may be a defined situation or multiple defined situations or real life achievements of the user or achievements of the user tracked by the companion device based on location, how a user uses the companion device, e.g. 262, how a consumer behaves or real life grades of user 262u, achievements in sports of user 262u or the athlete or team tracked by user 262u or other pursuits. In one or more embodiments, based on real world achievement the user of companion device, e.g. 262, may be provided with free products or services.

In one or more embodiments, an immersive companion device, e.g. 262, responsive to being associated with a defined situation may be responsive to a virtual universe or such other virtual multiverses. In at least one such embodiment, the immersive companion device, e.g. 262, may be responsive to at least one of location parameters within the virtual multiverse. For example, a multiverse for use with the immersive companion device may be Linden Lab's Second Life or SK Communication's cyber world.

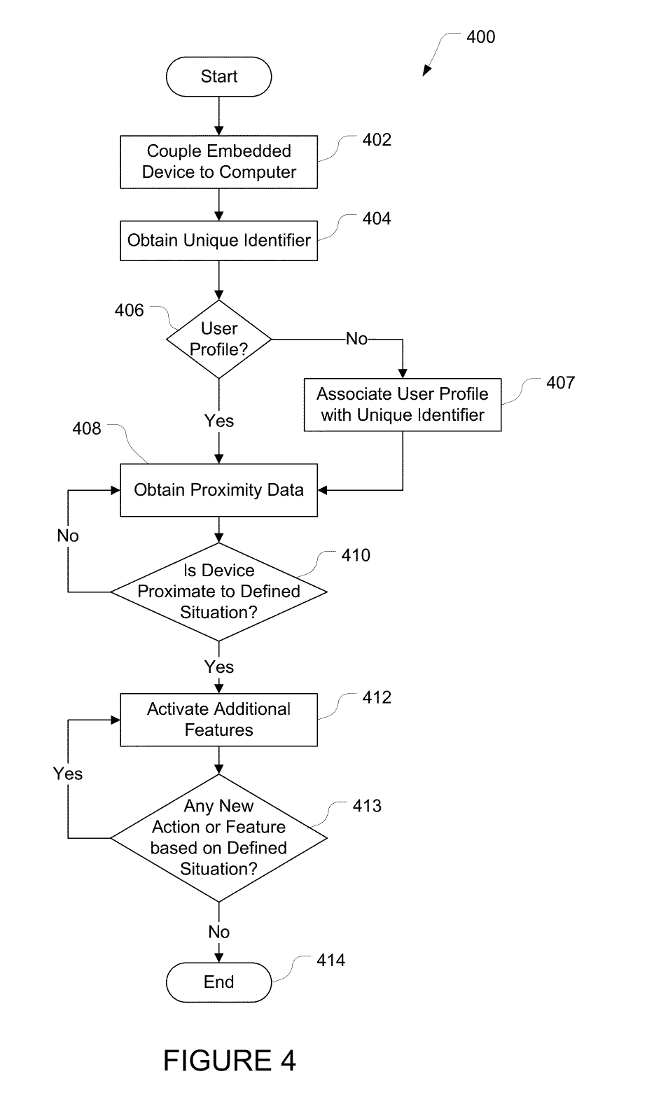

FIG. 4 is an exemplary flowchart for activating features based on a defined situation in the immersive companion device in accordance with one or more embodiments of the present invention. Process 400 beings at step 402. At step 402 the embedded computer system 300 is coupled to at least one computer 222. The embedded computer system may be coupled to at least one computer 222 using a network 210.

Processing continues to step 404 where at least one unique identifier is retrieved for the companion device, e.g. 262. The unique user identifier may be an email address, a serial number of the device, etc.

Processing continues to step 406 where it is determine if the companion device, e.g. 262, has a user profile associated with it. If there is no user profile associated with the companion device, a user profile may be associated with the companion device at step 407. The user profile may be stored as active instructions or as part of the unique identifier or in memory external to embedded computer system 300 or in at least one computer 222. The user profile may contain an email address. A user profile may be associated with a social network. Processing then continues to step 408. If at step 406, a determination is made that a user profile exists for the companion device, processing continues to step 408.

At step 408 proximity data is obtained by embedded computer system 300 for the companion device, e.g. 262. The proximity data to a location, e.g. 202, may be obtained from a GPS sensor, for example. In one or more embodiments the proximity data may be obtained from a wireless radio based on proximity to a Wireless access point.

Processing continues to step 410 where a decision is made as to the proximity of the companion device to a predefined situation. If the proximity data indicates that the companion device is not proximate to a defined situation, processing goes back to step 408.

However, if at step 410, a determination is made that the companion device, e.g. 262, is proximate to a defined situation, the processing proceeds to step 412 where additional features of the companion device are activated. The additional features may be activated by activating active instructions 306. Activating such additional features may impart new actions or features. Thus, the system checks at step 413 if any new action or feature resulted from the defined situation, and if so returns to step 412. Otherwise processing ends at 414. However, if the companion device encounters a new defined situation or there is a change in the defined situation, the entire process may repeat or at least the portion of the process, e.g. from step 408, may repeat to activate additional features or disable some features in the companion device.

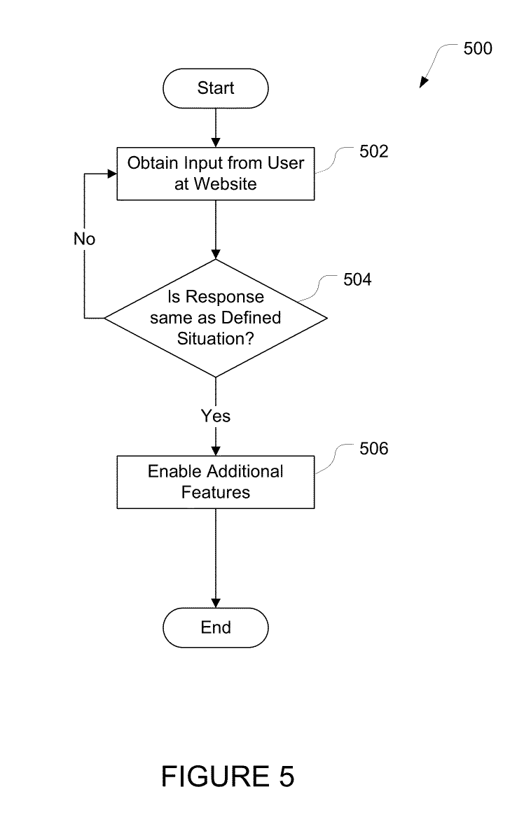

FIG. 5 is an exemplary flowchart for enabling additional features in the immersive companion device in accordance with one or more embodiments of the present invention. Process 500 illustrates a process for enabling features of the companion device, e.g. 262, based on user responses on a web site.

Process 500 begins at step 502 where the companion device, e.g. 262, obtains input from the user or the parent of the user. The user input may be promotional codes obtained from merchandise at retail locations or merchandise obtained with the purchase of retail goods. The user input may also be data relating to the name and user details such as birthday of the user. The user may input responses related to puzzles or other such promotions. The user may enter input such as identification of the right colors, identification of the right shapes on the webpage, “likes” in social media, etc.

Process continues to step 504 where the companion device determines if the response matches the defined situation. The defined situation may be a promotion code, correctly identifying the color or shape, or other data discussed above. In one or more embodiments, if the response is a defined situation then the additional features are enabled at step 506 and the process ends. However, if at step 504 a determination is made that the user entered an incorrect response, the process returns to 502 to obtain further input from the user.

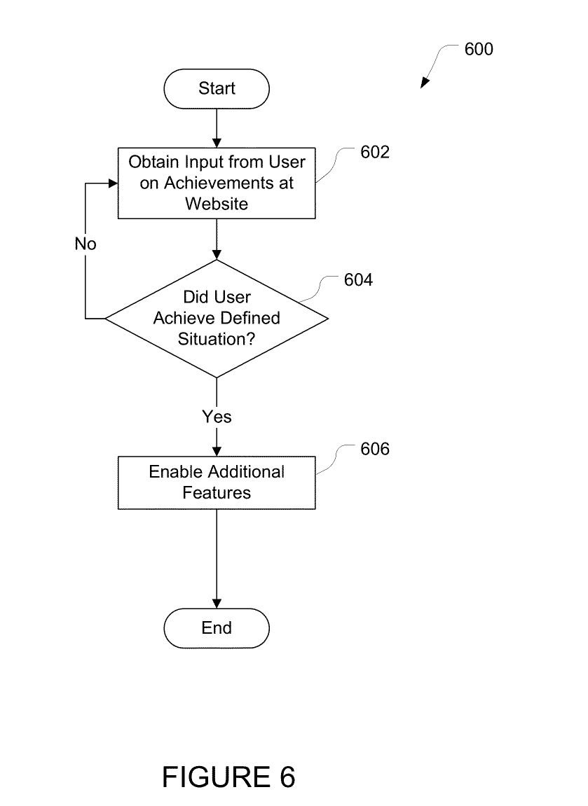

FIG. 6 is an exemplary flowchart for enabling additional features based on achievement in the immersive companion device in accordance with one or more embodiments of the present invention. Process 600 illustrates a process for enabling features of the companion device, e.g. 262, based on user achievements obtained from a website.

Process 600 beings at step 602 where the companion device, e.g. 262, obtains input from the user or the parent (administrator) of the user. The user input may be information about real life achievements, which the user or the parent (administrator) determines, will unlock achievements or additional features. The real life achievements may be based on visiting a location at least once. In one or more embodiments the real life achievements may be based on how a user uses the companion device, e.g. 262. In one or more embodiments the real life achievements may be based on how a user behaves over a period of time. The real life achievements may be based on achievements of the user such as good grades. The achievements may be based on real life achievements of the user such as performance in sports or extracurricular activities.

Process continues to 604 where the companion device, e.g. 262, determines if the user achieved the pre-defined situation. The defined situation as set forth herein above may be real life achievements of the user. If the user achieves the defined situation the process continues to 606 where the additional features of the companion device are enabled. However, if at step 604 a determination is made that the user did not achieve the defined situation, the process returns to 602 to obtain further input. When the companion device, e.g. 262, encounters a new defined situation or if there is a change in the defined situation, the entire process may repeat, or at least the portion of the process may repeat to activate additional features or disable some features in the companion device.

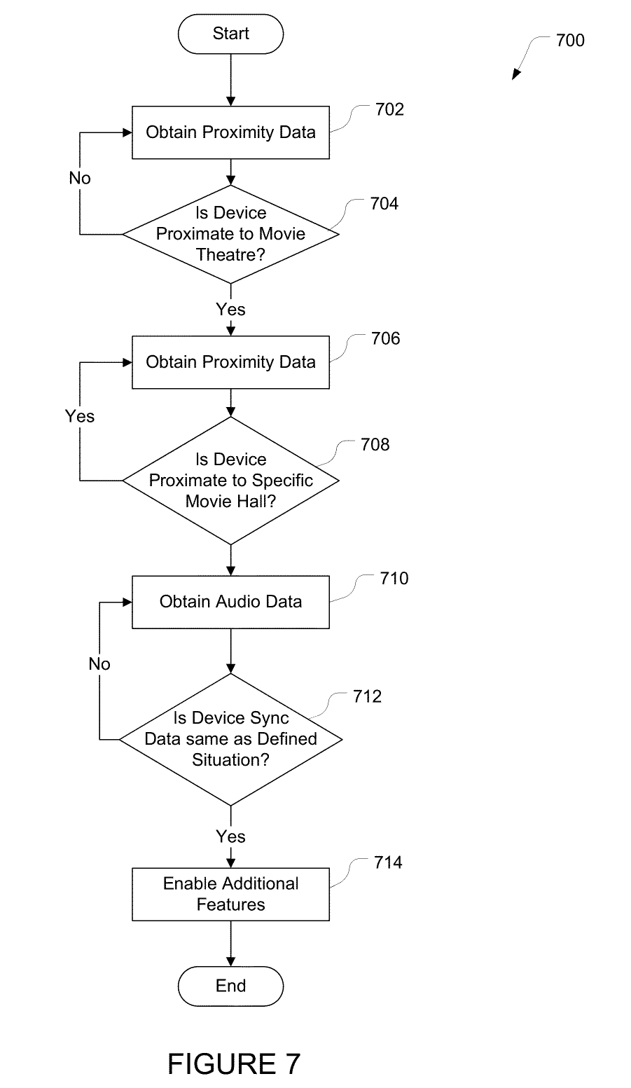

FIG. 7 is an exemplary flowchart of a process for enabling features of the companion device based on proximity to a movie theatre and content of the movie in accordance with one or more embodiments of the present invention. As illustrated, process 700 begins at step 702 where the companion device, e.g. 262, obtains proximity data. The process then proceeds to step 704. At step 704 proximity to a movie theatre is determined. If the companion device is not proximate to a movie theatre, the process returns to 702. However, if the companion device is proximate to a movie theatre, the process continues to step 706.

At 706 the companion device continues to receive polling data on proximity. The process then proceeds to step 708 to determine if the companion device, e.g. 262, is proximate to a specific movie screen or movie hall. If the companion device is not proximate to a specific movie screen or hall, processing returns to step 706. However, if at step 708 a determination is made that the companion device is proximate to a specific movie screen the process continues to step 710 to obtain audio data.

In one or more embodiments at step 710 the companion device may receive audio data through human interface/feedback device 330, e.g. via a microphone 316. In one or more embodiments, the audio data has a sync point at a specific location on the movie which matches a defined situation. The process continues to step 712.

At step 712 a determination is made if the device sync data matches the defined situation. If no, processing returns to step 710 to continue polling the audio data. However, if at step 712 a determination is made that the device sync data matches the defined situation, the process continues to step 714. At step 714 the additional features in the companion device may be enabled and execution ends.

The exemplary flow chart of process 700 may be adapted for use when the movie is later released and available to the user on a DVD, Blu-ray, streaming service or consumer electronics device. When the companion device, e.g. 262, encounters a new defined situation or if there is a change in the defined situation, the entire flow chart may repeat, or at least the portion of the routine may repeat to activate additional features or disable some features in the companion device.

While the invention herein disclosed has been described by means of specific embodiments and applications thereof, numerous modifications and variations could be made thereto by those skilled in the art without departing from the scope of the invention set forth in the claims.

What is claimed is:

1. A method for associating an immersive companion device with a defined situation:
providing a companion device to a user, said companion device having an embedded computer system with a unique identifier and a set of active instructions;
coupling said embedded computer system to a server computer via a communication network, wherein said server computer comprises a database with a user profile associated with said user and wherein said unique identifier of said companion device is associated with said user profile;
determining via said communication network if said embedded computer system is in proximity to a defined situation; and
activating features to be performed by said embedded computer system through said set of active instructions if said companion device is in proximity to said defined situation.

2. The method of claim 1, wherein said set of active instructions utilizes actuator motors which enable movement of said companion device.

3. The method of claim 1, wherein said unique identifier is an email address.

4. The method of claim 1, wherein said unique identifier is a serial number of said companion device.

5. The method of claim 1, wherein at least one of said set of active instructions comprises an instruction to enable audio output from said companion device.

6. The method of claim 1, wherein at least one of said active instructions comprises an instruction to enable lights to illuminate on said companion device.

7. The method of claim 1, wherein at least one of said active instructions comprises an instruction to enable a temperature control device on said companion device.

8. The method of claim 1, further comprising:
displaying on a computer interface associated with said server a set of active instructions enabled on said embedded computer system.

9. The method of claim 8, wherein said computer interface is a client side interface to said server.

10. The method of claim 1, further comprising:
storing a history of said features activated over time.

11. The method of claim 1, further comprising:
obtaining an input from a web interface location; and
causing said companion device to give a response based on said input from said web interface location.

12. The method of claim 1, further comprising:
obtaining input from an administrative user at a website location;
granting achievements to said user of said companion device based on said input; and
causing said companion device to give a response based on said achievements.

13. The method of claim 1, further comprising:
causing said companion device to give a response when in proximity to an incentive location.

14. An immersive companion device responsive to being associated with a defined situation comprising:
a shell body;
at least one embedded computer, said at least one embedded computer comprising at least one unique identifier module, a communication module and a set of active instructions, wherein said embedded computer is coupleable to a server computer via said communication module, wherein said server computer comprises a database with a user profile associated with said user and wherein said unique identifier is associated with said user profile; and
at least one human interface/feedback module coupled to the embedded computer,
wherein said server computer is configured to:
determine if said embedded computer is in proximity to a defined situation; and
activating features to be performed by said at least one human interface/feedback module through said set of active instructions if said embedded computer is in proximity to said defined situation.

15. The immersive companion device of claim 14, wherein said user profile is unique to said user.

16. The immersive companion device of claim 14, wherein said human interface/feedback module comprises an actuator and a transducer.

17. The immersive companion device of claim 16, wherein said human interface/feedback module further comprises a display unit.

18. The immersive companion device of claim 16, wherein said human interface/feedback module further comprises a speaker and a microphone.

19. A system for associating immersive companion devices responsive to defined situations comprising:
a server computer coupled to an external network;
at least one companion device communicatively coupled to said server computer via said external network, wherein each companion device comprises an embedded computer system with a unique identifier and a set of active instructions;
said server computer configured to communicate with each of said at least one embedded computer system to determine proximity to a defined situation; and
said server computer enabling functions to be performed by each of said at least one companion device when in proximity to said defined situation.

20. The system of claim 19, wherein said active instructions are updatable.
